(19) United States
(12) Patent Application Publication
(10) Pub. No.: US 2011/0091638 A1
(43) Pub. Date: Apr. 21, 2011

(54) METHOD OF ANIMAL SLAUGHTER

(75) Inventors: Erik Slinde, As (NO); Oddvin Sorheim, As (NO); Melvin Hunt, As (NO)

(73) Assignee: Nofima Mat AS

(21) Appl. No.: 12/682,435

(22) PCT Filed: Oct. 10, 2008
(86) PCT No.: PCT/GB08/03453

§ 371 Date: Nov. 29, 2010

(30) Foreign Application Priority Data
Oct. 10, 2007 (GB) 0719794.0

(51) Int. Cl. A22B 3/08; A22B 3/06; A23L 1/325

(52) U.S. Cl. 426/643; 452/66; 452/59

(57) ABSTRACT

The present invention relates to a method of slaughtering a non-human animal, which method comprises administering an anesthetic amount of carbon monoxide to said animal and subsequently killing the anaesthetized animal.

This invention relates to improvements in and relating to a method of slaughtering animals, as well as to apparatus therefor and the flesh of animals so slaughtered.

The conventional methods of slaughtering farmed vertebrate animals generally involve stunning with chemical, electrical, or mechanical methods followed by exsanguination, dismemberment, or decapitation. Gassing, for example with carbon dioxide has also been used. From a welfare point of view, especially in the case of fish, these methods are unsatisfactory since death by gassing is unacceptably slow and since other methods expose the animals to prolonged stress before death occurs.

Besides carbon dioxide, the use of carbon monoxide to asphyxiate animals, i.e. to kill them, has been proposed, e.g. in GB-A-135023 and JP-A-61-141835. GB-A-135023 indicated that death by carbon monoxide gassing resulted in preservation of the meat from decay. JP-A-61-141835 indicated that the carbon monoxide killing maintained a fresh colour for the meat.

Prolonged exposure to stress not only is unacceptable from a welfare point of view (welfare regulations can require death within one second rather than the seventeen seconds it can take to kill a pig with carbon dioxide gassing) but also results in undesirable modification of the harvested flesh due to the animal's stress reaction. Moreover, the quality of the flesh may deteriorate rapidly and rigor mortis may develop too quickly for pre-rigor filleting.

By way of example, conventional stunning of eels, a good model for development of acceptable slaughtering techniques, causes the fish to orient themselves vertically and to continue active movement thereby making collection difficult.

One solution, used in Australia, has been to anaesthetize fish before slaughter by administration of eugenol. This however has the drawback that it imparts an undesired flavour to the harvested flesh.

We have now found that slaughter may be achieved in a humane fashion, with little or no damage to the harvested flesh and without making filleting difficult, by first anaesthetizing the animal by exposure to carbon monoxide and then killing the animal by a different method, e.g. percussion, electrocution or exsanguination.

Thus viewed from one aspect the invention provides a method of slaughtering a non-human animal (preferably a vertebrate, in particular fish, bird, reptile or mammal, more preferably farmed fish, poultry or pigs, or cattle), which method comprises administering an anaesthetic amount of carbon monoxide to said animal and subsequently killing the anaesthetized animal, e.g. by percussion, electrocution or exsanguination.

Here it must be stressed that the carbon monoxide exposure in the method of the invention is to anaesthetize the animal and not to kill it. In this way the anaesthetized animal can be humanely exsanguinated and transported to a station where it is processed (e.g. by filleting, skinning, dismemberment, etc.) and packaged. As a result the delay between death and packaging may be minimized so allowing the meat to be packaged while in optimum condition even though the animals may have been anaesthetized in batches rather than individually. The carbon monoxide moreover serves as a preservative and to present the meat in a visually attractive manner.

JP-A-61-141835 (supra) also described pre-killing exposure to carbon monoxide but made no suggestion that the exposure should be such as to anaesthetize the animal rather than to simply promote a partial uptake of carbon monoxide by the haemoglobin and so affect the post slaughtering meat colour. Without anaesthetization, the benefits of post anaesthetizing handling and stress avoidance will of course not be obtained.

The anaesthetic amount of carbon monoxide may be administered directly as a gas or gas mixture to an air breathing animal or may be administered in water to a gilled animal, e.g. by exposing the animal to water containing dissolved carbon monoxide or by bubbling carbon monoxide or a gas mixture comprising carbon monoxide through water containing the gilled animal (e.g. fish) or other water dwelling species.

While a gas containing up to 100 mole % carbon monoxide may be used, in general it is preferred to use a gas mixture containing a minor amount of carbon monoxide on a molar basis, e.g. 1 to 20 mole %, preferably 2 to 10 mole %, especially 4 to 6 mole %, in order to expose the human operators to minimal risk. The gas mixture preferably contains oxygen at a content similar to or lower than that in air, e.g. 10 to 25 mole %, especially about 20 mole %. Likewise it preferably contains no carbon dioxide or carbon dioxide at a content less than 10 mole %.

The remainder of the gas in the mixture may typically be nitrogen or a noble gas. The use of nitrogen/carbon monoxide or noble gas/carbon monoxide mixtures is feasible although the use of air/carbon monoxide or nitrogen/oxygen/carbon monoxide mixtures is generally preferred both for convenience, cheapness, and the safety of the human operators. One preferred gas mixture is carbon monoxide 5 mole %, oxygen 20 mole %, nitrogen ad 100 mole %. Trace content of other gases, as in air, is of course acceptable.

Following anaesthetization, which can be detected by a calming or cessation of active movement—fish will swim calmly rather than exhibit a flight reaction—the animal may be slaughtered, optionally after percussion or electrical stunning. For fish, exposure to carbon monoxide generates anaesthesia within about 1 to 20 minutes, depending on the species. For salmon the period is about 3 to 6 minutes, for eels about 15 to 20 minutes, and for halibut about 1 to 3 minutes.

Carbon monoxide exposure is preferably such as to anaesthetize for at least 1 hour.

Slaughtering may, with mammals for example, involve opening a blood vessel, or alternatively may involve blood drainage, decapitation, gutting or the like. The slaughtered animal may be left intact or may be skinned filleted or otherwise dismembered in a conventional fashion. The slaughtered animal, or parts thereof, may be packaged (e.g. in cans or plastics sachets) and, if desired, chilled or frozen.

The technique of the invention is particularly applicable to fish (such as salmon, trout, eels, mackerel, and halibut), non-human mammals (such as pigs, sheep, cattle, goats, and deer), and birds (such as chickens, ducks, geese, pigeons, pheasant, and grouse). It is of course especially applicable to farmed animals; however it can be used for wild animals, such as fish, which are caught alive.

The method of the invention is advantageous not only in terms of animal welfare and meat handling, but also in terms of meat characteristics. Thus, for example, the method of the invention has an added advantage for fish or other non-human animals with highly vascularised muscle tissue, in particular salmonids, tuna, mackerel, beef cattle, and pigs, in that the flesh harvested has an appealing colour. A further advantage arises from the antimicrobial effect of the carbon monoxide within the tissue. Still further advantages are improved oxidative stability and flavour.

Slaughter in the method of the invention is not achieved by gassing with carbon monoxide but by other more rapid means—the exposure to carbon monoxide is merely to anaesthetize the animal. Slaughtering according to the method of the invention is thus effected before death by carbon monoxide poisoning occurs.

It is thought that the method of the invention achieves its effect through the displacement of oxygen from neuroglobin, an oxygen-binding globin in the central nervous system, which it is thought otherwise acts as a reservoir for oxygen and so prolongs the activity of the nervous system despite cessation of oxygen flow (through haemoglobin) to that system.

Viewed from a further aspect the invention provides animal flesh from a vertebrate animal slaughtered by the method of the invention.

Viewed from a yet further aspect the invention provides a method of anaesthetizing fish prior to slaughter or handling (e.g. vaccination or transfer, e.g. tank-to-tank, tank-to-cage, or cage-to-cage transfer) which method involves bubbling carbon monoxide through water in a container containing fish (e.g. a tank or cage) or transferring fish into water with carbon monoxide dissolved therein (e.g. at or about saturation level).

Viewed from a still further aspect the invention provides apparatus for anaesthetizing fish, said apparatus comprising a fish container (e.g. a tank or cage), a carbon monoxide gas source, and a gas diffuser arranged to introduce bubbles of gas from said source into water in said container.

In the apparatus of the invention, the gas source will typically be a pressurized gas tank containing a carbon monoxide or a carbon monoxide-containing gas mixture, optionally in conjunction with pressurized gas tanks containing other gases such as nitrogen and oxygen or in conjunction with an air-fed pump. The gas diffuser will typically comprise a perforated gas conduit disposed within or beneath the water in the container whereby bubbles of gas from the perforations enter the water in the container. The container will typically be a tank with water-tight walls or a perforated cage, e.g. a growing cage in a fish farm disposed in a lake or river or in the sea. Where a tank is used, this may be closed such that gas escaping from the water may be recirculated through the water or vented from the building in which the tank is located.

Viewed from a further aspect the invention provides an apparatus for slaughtering non-human vertebrate air-breathing animals which apparatus comprises a first device for administering carbon monoxide to said animal to anaesthetize it and a second device for subsequently killing said animal by decapitation, blood vessel opening, electrocution or skull percussion.

Where birds or land animals are to be slaughtered using the method of the invention, the carbon monoxide may be applied through a mask or hood, into a closed container (e.g. room) containing the animals, or through the perforated walls of a cage containing the animals.

Embodiments of the invention will now be described with reference to the following non-limiting Examples and the accompanying drawings in which:

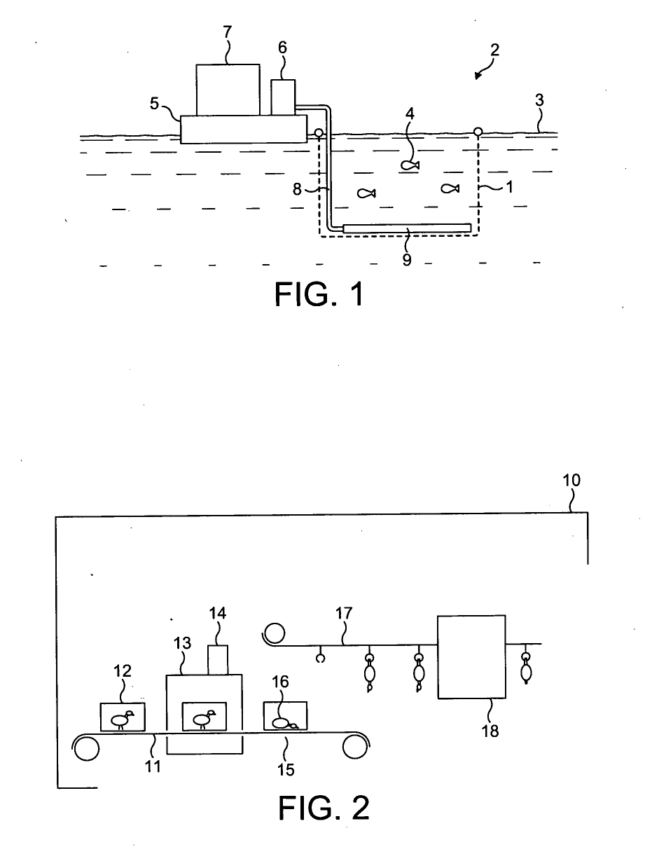

FIG. 1 is a schematic diagram of apparatus according to the invention for anaesthetizing fish; and

FIG. 2 is a schematic diagram of apparatus according to the invention for the slaughter of poultry.

Referring to FIG. 1 there is shown a fish cage 1 in an offshore fish farm 2. Cage 1 is disposed in seawater 3 and contains fish 4 (e.g. Atlantic salmon). Floating platform 5 carries a pressurized tank 6 containing a 5 mole % CO, 20 mole % O₂ and 75 mole % N₂ gas mixture and a fish slaughtering facility 7. Tank 6 is connected by gas pipe 8 to a perforated pipe mesh 9 at the base of cage 1.

When salmon are to be harvested, gas from tank 6 is bubbled into the seawater in cage 1 through pipe 8 and mesh 9. When the salmon cease to show a flight response, they are netted and taken to facility 7 to be slaughtered and filleted.

Referring to FIG. 2, there is shown a slaughterhouse facility 10 having a conveyor belt 11 which carries mesh cages 12 through a gas chamber 13 provided with a carbon monoxide source 14 (e.g. a pressurized gas tank as described in connection with FIG. 1 above) and thence to a transfer station 15 at which a human operator (not shown) takes the anaesthetized birds 16 from the cages and suspends them by their feet from an overhead traveling line 17. Traveling line 17 takes the suspended birds to a decapitator station 18 where the anaesthetized birds are decapitated before further processing (e.g. defeathering, skinning, filleting, etc).

### EXAMPLE 1

### Mackerel

Mackerel (Scomber scombrus) of about 700 g bodyweight were transferred from seawater into CO saturated seawater at about 16° C. in a 1 m×1 m plastic tank. CO saturation was achieved by pre-flushing the seawater (250 L) with 99.3% pure carbon monoxide (from Yara AS, Norway) for 5 minutes at 2.0 bar through two Wedge-lock diffusers (from Sterner Aqua, Norway). The CO content was monitored and never exceeded 50 ppm in the vicinity of the tank. The fish swam around with no apparent reaction until after about 5 minutes they showed signs of fatigue.

If exposure was contained for another 5 minutes the fish died and turned belly up.

Fillets had a white-reddish appearance.

### EXAMPLE 2

### Atlantic Salmon

Atlantic salmon (Salmo salar) of 0.7 to 1.5 kg bodyweight were transferred from seawater into CO saturated seawater (as in Example 1). By about 5 minutes the fish became more and more relaxed, sedated and were finally anesthetised. The fish showed no signs of stress or discomfort during this time.

If exposure was contained for more than one further minute the fish died and turned belly up.

Fillets had a normal, red appearance.

### EXAMPLE 3

### Atlantic Halibut

Atlantic halibut (Hippoglossus hippoglossus) of about 1.5 kg bodyweight were transferred into CO saturated seawater (as in Example 1). After about 2 minutes the flight reaction was not pronounced but they began to seek air at the surface.

If exposure was continued for a further two minutes, the fish died.

### EXAMPLE 4

### Eel

An eel (Anguilla anguilla) was transferred into CO saturated seawater as in Example 1. The eel swam around calmly and after 15 to 20 minutes was completely relaxed. It was removed from the tank and slaughtered. The fillets had a good appearance.

1. A method of slaughtering fish, which method comprises administering an anaesthetic amount of carbon monoxide to said animal and subsequently killing the anaesthetized animal.

2. (canceled)

3. A method as claimed in claim 1 wherein said carbon monoxide is passed into water containing said fish.

4. A method as claimed in claim 1 wherein said fish is placed in water containing dissolved carbon monoxide.

5. A method as claimed in claim 1 wherein said anaesthetized fish is stunned by percussion or electrocution before being killed.

6. A method as claimed in claim 1 wherein said carbon monoxide is administered in a gas mixture containing 1 to 20 mole % carbon monoxide.

7. A method as claimed in claim 6 wherein said gas mixture contains carbon monoxide, oxygen and nitrogen.

8. A method as claimed in claim 1 further comprising packaging the killed fish or parts thereof.

9. Flesh from a fish slaughtered by the method of claim 1.

10. A method of anaesthetizing fish prior to slaughter or handling, which method involves bubbling carbon monoxide through water in a container containing fish or transferring fish into water with carbon monoxide dissolved therein.

11. Apparatus for anaesthetizing fish, said apparatus comprising a fish container, a carbon monoxide gas source, and a gas diffuser arranged to introduce bubbles of gas from said source into water in said container.

12. (canceled)

13. A method as claimed in claim 3 wherein said anaesthetized fish is stunned by percussion or electrocution before being killed.

14. A method as claimed in claim 4 wherein said anaesthetized fish is stunned by percussion or electrocution before being killed.

15. A method as claimed in claim 3 wherein said carbon monoxide is administered in a gas mixture containing 1 to 20 mole % carbon monoxide.

16. A method as claimed in claim 4 wherein said carbon monoxide is administered in a gas mixture containing 1 to 20 mole % carbon monoxide.

17. A method as claimed in claim 5 wherein said carbon monoxide is administered in a gas mixture containing 1 to 20 mole % carbon monoxide.

18. A method as claimed in claim 3 further comprising packaging the killed fish or parts thereof.

19. A method as claimed in claim 4 further comprising packaging the killed fish or parts thereof.

20. A method as claimed in claim 5 further comprising packaging the killed fish or parts thereof.

21. A method as claimed in claim 6 further comprising packaging the killed fish or parts thereof.

22. A method as claimed in claim 7 further comprising packaging the killed fish or parts thereof.

23. Flesh from a fish slaughtered by the method of claim 3.

24. Flesh from a fish slaughtered by the method of claim 4.

25. Flesh from a fish slaughtered by the method of claim 5.

26. Flesh from a fish slaughtered by the method of claim 6.

27. Flesh from a fish slaughtered by the method of claim 7.
